(19) United States
(12) Patent Application Publication
(10) Pub. No.: US 2014/0260163 A1
(43) Pub. Date: Sep. 18, 2014

(54) Cotton Conveying Structure For A Cotton Harvester

(71) Applicant: DEERE & COMPANY, Moline, IL (US)

(72) Inventors: JEFFREY R. FOX, MINBURN, IA (US); THOMAS G. BARTLETT, ANKENY, IA (US); THOMAS H. DEGROODT, EVANS, GA (US); JERRY E. WHITE, ALTOONA, IA (US); KEVIN J. GOERING, CAMBRIDGE, IA (US); JUSTIN E. HUMMEL, DES MOINES, IA (US); JAMES T. NOONAN, BONDURANT, IA (US)

(73) Assignee: DEERE & COMPANY, Moline, IL (US)

(21) Appl. No.: 13/834,969

(22) Filed: Mar. 15, 2013

(51) Int. Cl. A01D 51/00

(52) U.S. Cl. CPC A01D 51/00
USPC 56/33; 56/28

(57) ABSTRACT

A cotton conveying structure for a cotton harvester. The cotton harvester comprising a receptacle. A harvesting structure is configured for harvesting cotton. A first cross auger is in communication with the harvesting structure for receiving cotton therefrom. The first cross auger is coupleable to a forward portion of the cotton harvester. A second cross auger is in communication with the harvesting structure for receiving cotton therefrom. The second cross auger is coupleable to a forward portion of the cotton harvester adjacent the first cross auger. A first duct is in communication with the first cross auger. A first cleaner is in communication with the first duct. A second duct is in communication with the second cross auger and spaced from the first duct. A second cleaner is in communication with the second duct. The first and second cleaners are configured to transfer cotton to the receptacle.

### FIELD OF THE DISCLOSURE

The present disclosure generally relates to cotton harvesters, and more particularly to a cotton conveying structure for cotton harvesters.

### BACKGROUND OF THE DISCLOSURE

In order to harvest cotton, cotton harvesters such as a cotton stripper, often include a cross auger to transfer cotton to a center of the cotton harvester. Cotton is propelled via a vacuum through a single duct, which extends upwardly behind a cotton harvester cab and forwardly of a cleaner or burr extractor.

### SUMMARY OF THE DISCLOSURE

In one embodiment, a cotton conveying structure for a cotton harvester is disclosed. The cotton harvester comprising a receptacle. A harvesting structure is configured for harvesting cotton. A first cross auger is in communication with the harvesting structure for receiving cotton therefrom. The first cross auger is coupleable to a forward portion of the cotton harvester. A second cross auger is in communication with the harvesting structure for receiving cotton therefrom. The second cross auger is coupleable to a forward portion of the cotton harvester adjacent the first cross auger. A first duct is in communication with the first cross auger. A first cleaner is in communication with the first duct. A second duct is in communication with the second cross auger and spaced from the first duct. A second cleaner is in communication with the second duct. The first and second cleaners are configured to transfer cotton to the receptacle at a rate that enables greater productivity than using only one cleaner. Additional ducts are contemplated by this disclosure to provide even greater productivity. Additional cleaners are also contemplated by this disclosure to provide greater productivity.

In another embodiment, a cotton harvester is disclosed. The cotton harvester comprises a cotton conveying structure. The cotton conveying structure comprises a harvesting structure configured for harvesting cotton. A first cross auger is in communication with the harvesting structure for receiving cotton therefrom. The first cross auger is coupleable to a forward portion of the cotton harvester. A second cross auger is in communication with the harvesting structure for receiving cotton therefrom. The second cross auger is coupleable to a forward portion of the cotton harvester adjacent the first cross auger. A first duct is in communication with the first cross auger. A first cleaner is in communication with the first duct. A second duct is in communication with the second cross auger and spaced from the first duct. A second cleaner is in communication with the second duct. An accumulator is in communication with the first cleaner and the second cleaner for receiving cotton therefrom. A feeder is in communication with the accumulator for receiving cotton therefrom. The feeder is configured to compress the cotton. A round module builder is in communication with the feeder for receiving cotton therefrom. The round module builder is configured to form a round module of cotton. The first and second cleaners are configured to transfer cotton to the receptacle at a rate that enables greater productivity than using only one cleaner. Additional ducts are contemplated by this disclosure to provide even greater productivity. Additional cleaners are also contemplated by this disclosure to provide greater productivity.

Other features and aspects will become apparent by consideration of the detailed description and accompanying drawings.

### BRIEF DESCRIPTION OF THE DRAWINGS

FIG. 1 is a perspective view of a cotton harvester including a cotton conveying structure according to one embodiment.

FIG. 2 is a partial top view of the cotton harvester of FIG. 1.

FIG. 3 is a side view of the cotton harvester of FIG. 1.

FIG. 4 is a partial top view of a cotton harvester according to another embodiment.

FIG. 5 is a partial top view of a cotton harvester according to yet another embodiment.

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Further embodiments of the invention may include any combination of features from one or more dependent claims, and such features may be incorporated, collectively or separately, into any independent claim.

### DETAILED DESCRIPTION

FIG. 1 illustrates a cotton harvester 10 according to one embodiment. The illustrated cotton harvester 10 is a cotton stripper 15.

The cotton harvester 10 includes a chassis 20. The chassis 20 is supported by front wheels 25 and rear wheels 30. The harvester 10 is adapted for movement through a field 35 to harvest cotton. An operator station 40 is supported by the chassis 20. A power module 45 may be supported below the chassis 20. The chassis 20 is generally similar to that shown and described in commonly assigned U.S. Pat. No. 7,631,716, the entire contents of which are hereby incorporated by reference. However, the operator station 40 is moved forward around thirty inches on the chassis 20 to provide more space behind the operator station 40. Other operator station 40 positions on the chassis 20 are contemplated by this disclosure.

A harvesting structure 50 is coupleable to the chassis 20. The harvesting structure 50 includes an auger housing 55 that is adjustably supported for vertical movement relative to the field 35. The harvesting structure 50 is configured to remove cotton from the field 35. The illustrated harvesting structure 50 includes a plurality of stripper row units 60. Eight to twelve stripper row units 60 are contemplated by this disclosure. More than twelve stripper row units 60 are also contemplated by this disclosure. Each stripper row unit 60 includes a row-receiving area 65 with conventional counter-rotating brush structure driven by hydraulic pressure for removing cotton plant material including cotton burrs and cotton fibers from cotton plants. The removed material is conveyed rearwardly by stripper row unit augers 70 in the stripper row units 60 to cross auger structure 75 (FIG. 2).

With reference to FIG. 2, the cross auger structure 75 includes a first cross auger 80. A first portion 85 of the first cross auger 80 includes a left-hand flighting 90. A second portion 95 of the first cross auger 80 includes a right-hand flighting 100. The left-hand flighting 90 and the right-hand flighting 100 are configured to move cotton towards a center portion 105 of the first cross auger 80. Alternatively, the first portion 85 may include right-hand flighting 100 and the second portion 95 may include left-hand flighting 90 and the first cross auger 80 may be rotated in an alternate direction.

The cross auger structure 75 includes a second cross auger 110. A first portion 115 of the second cross auger 110 includes a left-hand flighting 120. A second portion 125 of the second cross auger 110 includes a right-hand flighting 130. The left-hand flighting 120 and the right-hand flighting 130 are configured to move cotton towards a center portion 135 of the second cross auger 110.

A first duct 140 is coupleable to the cross auger structure 75. The first duct 140 is in communication with the first cross auger 80 and configured to receive cotton therefrom.

Referring to FIG. 1, a first cleaner 145 is in communication with the first duct 140. The first cleaner 145 is configured to receive cotton from the first duct 140 and remove debris from the cotton as shown and described in commonly assigned U.S. Pat. No. 5,806,290, the entire contents of which are hereby incorporated by reference.

With reference to FIG. 2, a second duct 150 is coupleable to the cross auger structure 75. The second duct 150 is in communication with the second cross auger 110 and configured to receive cotton therefrom.

Referring to FIG. 1, a second cleaner 155 is in communication with the second duct 150. The second cleaner 155 is configured to receive cotton from the second duct 150 and remove debris from the cotton as shown and described in commonly assigned U.S. Pat. No. 5,806,290, the entire contents of which are hereby incorporated by reference.

An accumulator 160 is in communication with the first cleaner 145 and the second cleaner 155. The accumulator 160 is configured to receive cleaned cotton from the first cleaner 145 and the second cleaner 155.

A feeder 165 is coupleable to the chassis 20. The feeder 165 is configured to receive cotton from the accumulator 160. The feeder 165 is configured to compress the cotton via a plurality of rollers and transfer the cotton to a receptacle 170.

The illustrated receptacle 170 is a round module builder 175 that includes a first module-forming portion 180 in communication with the feeder 165 for receiving the cotton therefrom. A second module-forming portion 185 is pivotally coupleable to the first module-forming portion 180. An extendable and retractable cylinder 190 is coupleable to the second module-forming portion 185. The extendable and retractable cylinder 190 is configured to pivot the second module-forming portion 185 relative to the first module-forming portion 180. The first and second module forming portions 180, 185 of the round module builder 175 are configured to form a round module or bale of cotton.

With continued reference to FIG. 1, a module handling system 195 is positioned adjacent the round module builder 175 for receiving the round module. The module handling system 195 temporarily supports the round module and then discharges it from the cotton harvester 10.

In operation, the cotton harvester 10 is driven through the field 35 to harvest cotton. The illustrated harvesting structure 50 strips cotton from cotton plants in the field 35. Cotton is transferred by the first duct 140 and the second duct 150 to the first cleaner 145 and the second cleaner 155 where debris is removed. The first duct 140, the second duct 150, the first cleaner 145, and the second cleaner 155 enable the cotton harvester 10 to harvest more cotton at a higher rate of speed compared to a cotton harvester with only one cleaner. Additional ducts and cleaners are contemplated by this disclosure in order to provide maximum productivity and non-stop harvest. Cotton is then transferred to the accumulator 160. The accumulator 160 holds the cotton until a predetermined cotton level is reached and then transfers the cotton to the feeder 165. In an exemplary embodiment, the accumulator 160 transfers cotton to the feeder 165 four times for each round module produced. When the feeder 165 receives cotton, the plurality of rollers is activated to compress the cotton. The compressed cotton is transferred to the round module builder 175.

After the round module builder 175 receives compressed cotton, the compressed cotton is rotated into the round module. Once the round module has been wrapped, the second module-forming portion 185 is pivoted relative to the first module-forming portion 180, and the round module can be ejected onto the module handling system 195. The module handling system 195 supports the round module and then discharges it from the cotton harvester 10.

FIG. 4 illustrates a harvesting structure 250 of a cotton harvester 210 according to another embodiment. The cotton harvester 210 includes features similar to the cotton harvester 10 of FIG. 1, and therefore, like components have been given like reference numbers plus 200 and only differences between the cotton harvesters 10 and 210 will be discussed in detail below.

A cross auger structure 275 includes a first cross auger 280. The first cross auger 280 includes a left-hand flighting 290. The left-hand flighting 290 is configured to move cotton outwardly towards a first duct 340. Alternatively, the first cross auger 280 may include right-hand flighting and the first cross auger 280 may be rotated in an alternate direction.

The cross auger structure 275 includes a second cross auger 310. The second cross auger 310 includes a left-hand flighting 320. The left-hand flighting 320 is configured to move cotton outwardly towards a second duct 350. Alternatively, the second cross auger 310 may include right-hand flighting and the second cross auger 310 may be rotated in an alternate direction.

FIG. 5 illustrates a harvesting structure 450 of a cotton harvester 410 according to another embodiment. The cotton harvester 410 includes features similar to the cotton harvester 10 of FIG. 1, and therefore, like components have been given like reference numbers plus 400 and only differences between the cotton harvesters 10 and 410 will be discussed in detail below.

A cross auger structure 475 includes a first cross auger 480. A first portion 485 of the first cross auger 480 includes a left-hand flighting 490. A second portion 495 of the first cross auger 480 includes a right-hand fighting 500. The left-hand flighting 490 and the right-hand flighting 500 are configured to move cotton towards a center portion 505 of the first cross auger 480. Alternatively, the first portion 485 may include right-hand flighting 500 and the second portion 495 may include left-hand flighting 490 and the first cross auger 480 may be rotated in an alternate direction. The first cross auger 480 communicates cotton to a first duct 540.

The cross auger structure 475 includes a second cross auger 510 positioned adjacent the first cross auger 480. A first portion 515 of the second cross auger 510 includes a left-hand flighting 520. A second portion 525 of the second cross auger 510 includes a right-hand flighting 530. The left-hand flighting 520 and the right-hand flighting 530 are configured to move cotton towards a center portion 535 of the second cross auger 510. The second cross auger 510 communicates cotton to a second duct 550.

The cross auger structure 475 includes a third cross auger 600 positioned adjacent the first cross auger 480. A first portion 605 of the third cross auger 600 includes a left-hand flighting 610. A second portion 615 of the third cross auger 600 includes a right-hand flighting 620. The left-hand flighting 610 and the right-hand flighting 620 are configured to move cotton towards a center portion 625 of the third cross auger 600. The third cross auger 600 communicates cotton to the first duct 540.

The cross auger structure 475 includes a fourth cross auger 630 positioned adjacent the second cross auger 510. A first portion 635 of the fourth cross auger 630 includes a left-hand flighting 640. A second portion 645 of the fourth cross auger 630 includes a right-hand flighting 650. The left-hand flighting 640 and the right-hand flighting 650 are configured to move cotton towards a center portion 655 of the fourth cross auger 630. The fourth cross auger 630 communicates cotton to the second duct 550.

Various features are set forth in the following claims.

What is claimed is:

1. A cotton conveying structure for a cotton harvester comprising a receptacle, the cotton conveying structure comprising:
a harvesting structure configured for harvesting cotton;
a first cross auger in communication with the harvesting structure for receiving cotton therefrom, the first cross auger coupleable to a forward portion of the cotton harvester,
a second cross auger in communication with the harvesting structure for receiving cotton therefrom, the second cross auger coupleable to a forward portion of the cotton harvester adjacent the first cross auger;
a first duct in communication with the first cross auger;
a first cleaner in communication with the first duct, the first cleaner configured to transfer cotton to the receptacle;
a second duct in communication with the second cross auger and spaced from the first duct; and
a second cleaner in communication with the second duct, the second cleaner configured to transfer cotton to the receptacle.

2. The cotton conveying structure of claim 1, further comprising a cotton harvester comprising an accumulator in communication with the first cleaner and the second cleaner for receiving cotton therefrom, a feeder in communication with the accumulator for receiving cotton therefrom, the feeder configured to compress the cotton, and wherein the receptacle is a round module builder in communication with the feeder for receiving cotton therefrom.

3. The cotton conveying structure of claim 1, wherein the harvesting structure comprises a plurality of cotton stripper row units.

4. The cotton conveying structure of claim 1, wherein the first cross auger comprises a left-hand flighting on a first portion and a right-hand flighting on a second portion, the left-hand flighting and the right-hand flighting configured to move cotton towards a center portion of the first cross auger.

5. The cotton conveying structure of claim 1, wherein the second cross auger comprises a left-hand fighting on a first portion and a right-hand flighting on a second portion, the left-hand flighting and the right-hand flighting configured to move cotton towards a center portion of the second cross auger.

6. The cotton conveying structure of claim 1, further comprising a third cross auger in communication with the harvesting structure for receiving cotton therefrom, the third cross auger coupleable to a forward portion of the cotton harvester adjacent the first cross auger, the first duct in communication with the first cross auger and the third cross auger.

7. The cotton conveying structure of claim 1, further comprising a fourth cross auger in communication with the harvesting structure for receiving cotton therefrom, the fourth cross auger coupleable to a forward portion of the cotton harvester adjacent the second cross auger, the second duct in communication with the second cross auger and the fourth cross auger.

8. A cotton harvester comprising:
a cotton conveying structure comprising a harvesting structure configured for harvesting cotton, a first cross auger in communication with the harvesting structure for receiving cotton therefrom, the first cross auger coupleable to a forward portion of the cotton harvester, a second cross auger in communication with the harvesting structure for receiving cotton therefrom, the second cross auger coupleable to a forward portion of the cotton harvester adjacent the first cross auger, a first duct in communication with the first cross auger, a first cleaner in communication with the first duct, a second duct in communication with the second cross auger and spaced from the first duct, and a second cleaner in communication with the second duct;
an accumulator in communication with the first cleaner and the second cleaner for receiving cotton therefrom;
a feeder in communication with the accumulator for receiving cotton therefrom, the feeder configured to compress the cotton; and
a round module builder in communication with the feeder for receiving cotton therefrom, the round module builder configured to form a round module of cotton.

9. The cotton conveying structure of claim 8, wherein the harvesting structure comprises a plurality of cotton stripper row units.

10. The cotton conveying structure of claim 8, wherein the first cross auger comprises a left-hand flighting on a first portion and a right-hand flighting on a second portion, the left-hand flighting and the right-hand flighting configured to move cotton towards a center portion of the first cross auger.

11. The cotton conveying structure of claim 8, wherein the second cross auger comprises a left-hand flighting on a first portion and a right-hand flighting on a second portion, the left-hand flighting and the right-hand flighting configured to move cotton towards a center portion of the second cross auger.

12. The cotton conveying structure of claim 8, further comprising a third cross auger in communication with the harvesting structure for receiving cotton therefrom, the third cross auger coupleable to a forward portion of the cotton harvester adjacent the first cross auger, the first duct in communication with the first cross auger and the third cross auger.

13. The cotton conveying structure of claim 1, further comprising a fourth cross auger in communication with the harvesting structure for receiving cotton therefrom, the fourth cross auger coupleable to a forward portion of the cotton harvester adjacent the second cross auger, the second duct in communication with the second cross auger and the fourth cross auger.
